(19) United States
(12) Patent Application Publication
(10) Pub. No.: US 2026/0141890 A1
(43) Pub. Date: May 21, 2026

(54) AI-Based System for Vocal Lyric Modification

(71) Applicant: John Chowhan Park, Centreville, VA (US)

(72) Inventor: John Chowhan Park, Centreville, VA (US)

(21) Appl. No.: 19/387,716

(22) Filed: Nov. 13, 2025

Related U.S. Application Data
(60) Provisional application No. 63/722,614, filed on Nov. 20, 2024.

(51) Int. Cl. G10L 13/027; G10H 1/00; G10L 13/033

(52) U.S. Cl. CPC G10L 13/027; G10H 1/0025; G10L 13/0335; G10H 2210/041; G10H 2210/066; G10H 2210/111

(57) ABSTRACT

A system and method leveraging artificial intelligence to modify song lyrics while preserving the unique vocal characteristics of the original artist, including pitch, timbre, and expressive style. The system processes an input music file, separates vocal and instrumental components, and uses a trained singing voice model to synthesize a modified vocal track that seamlessly integrates new lyrics. The output retains the original artist's distinct vocal qualities, ensuring a realistic and natural rendition. Applications include content localization, personalized music production, and media streaming, enabling efficient lyric customization without requiring re-recording by the artist.

### BACKGROUND OF THE INVENTION

Music has always been a powerful medium for expression, storytelling, and cultural connection. Artists spend significant time and effort creating songs that resonate with diverse audiences. However, the process of personalizing or localizing songs for specific audiences, languages, or cultural preferences often requires the artist to re-record the song in its entirety. This process can be time-consuming, costly, and logistically challenging, especially for global or large-scale distribution.

Advancements in artificial intelligence (AI), neural networks, and machine learning have opened new possibilities in audio processing, including voice synthesis and modification. These technologies allow for highly realistic replication of an artist's vocal style and characteristics. Yet, current methods for lyric modification often fall short of maintaining the integrity of the artist's unique vocal attributes, such as pitch, timbre, and expressive style. This gap has limited the widespread use of AI-based systems for personalizing music or adapting it to new contexts.

In parallel, the growing demand for personalized content in streaming and downloading platforms highlights the need for systems capable of dynamically tailoring music for individual users. From inserting personalized names to replacing sensitive or localized lyrics, there exists a pressing need for a system that can make such modifications seamlessly while preserving the essence of the original performance.

The present invention addresses these challenges by introducing a system and method that leverages AI to modify song lyrics while maintaining the original artist's vocal characteristics. By allowing efficient and realistic customization of music, this invention supports applications such as content localization, personalized music production, and enhanced user engagement in media streaming and downloading platforms, all without requiring the artist to re-record their performance.

### SUMMARY OF THE INVENTION

A computer-implemented method according to some embodiments of the disclosure may comprise identifying a first voice part in first vocal data that needs to be replaced, wherein the first vocal data captures a singing or vocal performance by an artist, loading or initializing a singing voice model, wherein the singing voice model is trained with at least one song or audio data containing the artist's voice, or is configured to take conditional data that includes the artist's voice or data specifying or capturing vocal characteristics of the artist, generating linguistic data from input data, generating a second voice part through a process that includes performing inference with the singing voice model conditioned on the linguistic data, and replacing the first voice part in the first vocal data with the second voice part to generate second vocal data, wherein the singing voice model is developed, adapted, trained, or configured using neural network, machine learning, or artificial intelligence. The linguistic data may comprise phonemes. The linguistic data may comprise phonemes and the duration of each phoneme. Syllabic melisma or syllabic compression may be performed on the input data to generate the linguistic data. The computer-implemented method may further comprise synthesizing the second vocal data with instrumental data, wherein the first vocal data and the instrumental data are generated from music data or a music file. For each frame in the first voice part and a corresponding frame in the second voice part, both frames occurring at the same time position, the difference in fundamental frequency between the frame of the first voice part and the frame of the second voice part may be less than 5 percent, wherein the duration of each frame is greater than 5 ms and less than 100 ms. The computer-implemented method may further comprise receiving user data from a music or video streaming platform, generating the input data based on the user data or assign the user data as the input data, and providing music or video including the second vocal data, or music or video generated with the second vocal data, for playback or output on a user device. The computer-implemented method may further comprise receiving user data from a music or video downloading platform, generating the input data based on the user data or assign the user data as the input data, and providing music or video including the second vocal data, or music or video generated with the second vocal data, for download on a user device. The computer-implemented method may further comprise receiving the name of a user as input data from a music or video streaming platform or a music downloading platform, and providing music or video including the second vocal data, or music or video generated with the second vocal data, for streaming or download on a user device. The singing voice model may encode at least one parameter that represents the unique timbre of the artist's voice. Performing inference with the singing voice model may be further conditioned on a pitch contour or a sequence of musical notes. Data for the pitch contour or the sequence of musical notes may be extracted from the first voice part. The singing voice model data may include at least one value corresponding to at least one of intensity of phonation, increase or decrease of the intensity, singing expressions, or voice quality. The duration of the second voice part may be shorter than the duration of the music data or file. The duration of the second voice part may be less than 10% of the duration of the music data or file. The difference between Mel-Frequency Cepstral Coefficients of the second voice part and Mel-Frequency Cepstral Coefficients of at least a portion of the first vocal data may be less than 20%. Performing inference with the singing voice model may be further conditioned on a loudness profile, expression and style embeddings, spectral features, artist embedding, vibrato rate, or vibrato depth. Performing inference with the singing voice model may be further conditioned on the first voice part. The input data may be text or speech data.

A computer-implemented method according to an embodiment of the disclosure may comprise identifying a first voice part that needs to be replaced in music data or a music file, wherein the music data or file captures a singing or vocal performance by an artist, loading or initializing a singing voice model, wherein the singing voice model is trained with at least one song or audio data containing the artist's voice, or is configured to take conditional data that includes the artist's voice or data specifying or capturing vocal characteristics of the artist, generating a second voice part through a process that includes performing inference with the singing voice model conditioned on input data, and replacing the first voice part in the music data or file with the second voice part, or insert the second voice part into the first voice part in the music data or file, wherein the singing voice model data is developed, adapted, trained, or configured using neural network, machine learning, or artificial intelligence. The input data may be text data or audio data, wherein the audio data does not include the artist's voice or data specifying or capturing vocal characteristics of the artist. The input data may comprise phonemes. The input data may comprise phonemes and the duration of each phoneme. Syllabic melisma or syllabic compression may be performed to generate the input data. For each frame in the first voice part and a corresponding frame in the second voice part, both frames occurring at the same time position, the difference in fundamental frequency between the frame of the first voice part and the frame of the second voice part may be less than 5 percent, wherein the duration of each frame is greater than 5 ms and less than 100 ms. The computer-implemented method may further comprise receiving user data from a music or video streaming platform, generating the input data based on the user data or assign the user data as the input data, and providing music or video including the second voice part, or music or video generated with the second voice part, for playback or output on a user device. The computer-implemented method may further comprise receiving user data from a music or video downloading platform, generating the input data based on the user data or assign the user data as the input data, and providing music or video including the second voice part, or music or video generated with the second voice part, for download on a user device. The computer-implemented method may further comprise receiving the name of a user as input data from a music or video streaming platform or a music downloading platform, and providing music or video including the second voice part, or music or video generated with the second voice part, for streaming or download on a user device. The singing voice model may encode at least one parameter that represents the unique timbre of the artist's voice. performing inference with the singing voice model may be further conditioned on a pitch contour or a sequence of musical notes. data for the pitch contour or the sequence of musical notes may be extracted from the first voice part. the singing voice model data may include at least one value corresponding to at least one of intensity of phonation, increase or decrease of the intensity, singing expressions, or voice quality. The duration of the second voice part may be shorter than the duration of the music data or file. The duration of the second voice part may be less than 10% of the duration of the music data or file. The difference between Mel-Frequency Cepstral Coefficients of the second voice part and Mel-Frequency Cepstral Coefficients of at least a portion of the music data or file may be less than 20%. Performing inference with the singing voice model may be further conditioned on a loudness profile, expression and style embeddings, spectral features, artist embedding, vibrato rate, or vibrato depth.

A computer-implemented method according to an embodiment of the disclosure may comprise loading or initializing a singing voice model, generating a voice part through a process that includes performing inference with the singing voice model conditioned on input data, and serially extending a first audio segment with the voice part to generate a second audio segment, wherein the first audio segment captures a singing or vocal performance by an artist, wherein the singing voice model is trained with at least one song or audio data containing the artist's voice, or is configured to take conditional data that includes the artist's voice or data specifying or capturing vocal characteristics of the artist, wherein the singing voice model data is developed, adapted, trained, or configured using neural network, machine learning, or artificial intelligence. The input data may be text data or audio data, wherein the audio data does not include the artist's voice or data specifying or capturing vocal characteristics of the artist. The input data may comprise phonemes. The input data may comprise phonemes and the duration of each phoneme. Syllabic melisma or syllabic compression may be performed to generate the input data. For each frame in the first voice part and a corresponding frame in the second voice part, both frames occurring at the same time position, the difference in fundamental frequency between the frame of the first voice part and the frame of the second voice part may be less than 5 percent, wherein the duration of each frame is greater than 5 ms and less than 100 ms. The computer-implemented method may further comprise receiving user data from a music or video streaming platform, generating the input data based on the user data or assign the user data as the input data, and providing music or video including the second audio segment, or music or video generated with the second audio segment, for playback or output on a user device. The computer-implemented method may further comprise receiving user data from a music or video downloading platform, generating the input data based on the user data or assign the user data as the input data, and providing music or video including the second audio segment, or music or video generated with the second audio segment, for download on a user device. The computer-implemented method may further comprise receiving the name of a user as input data from a music or video streaming platform or a music downloading platform, and providing music or video including the second audio segment, or music or video generated with the second audio segment, for streaming or download on a user device. The singing voice model data may include at least one value corresponding to timbre. Performing inference with the singing voice model may be further conditioned on a pitch contour or a sequence of musical notes. The singing voice model data may include at least one value corresponding to at least one of intensity of phonation, increase or decrease of the intensity, singing expressions, or voice quality. The input data may be generated by text-to-speech processing. The duration of the voice part may be less than 10% of the duration of the first audio segment. The difference between Mel-Frequency Cepstral Coefficients of the voice part and Mel-Frequency Cepstral Coefficients of at least a portion of the first audio segment may be less than 20%. Performing inference with the singing voice model may be further conditioned on a loudness profile, expression and style embeddings, spectral features, artist embedding, vibrato rate, or vibrato depth.

The system according to some embodiments of the disclosure may include at least one process and memory including instructions operable to be executed by the at least one processor to configure the system to perform any of above computer-implemented method.

### DETAILED DESCRIPTION OF THE INVENTION

The invention provides a system and method that uses AI to replace part or all of the lyrics in a song while preserving the unique vocal characteristics of the original artist, including elements like pitch, timbre, and expressive style. The system processes an input music file, which contains both vocal and instrumental components, and separates the vocal track to allow for modification. After receiving new lyric input, the system generates a synthesized vocal performance that seamlessly integrates the specified lyrics. The generated output retains the original artist's distinct vocal qualities, ensuring that the modified song sounds as if it is genuinely sung by the artist. This approach enables efficient lyric customization for applications such as content localization, personalized music production, and media streaming, without requiring the artist to re-record the song.

In some embodiments, when a music file is selected by the user for streaming or playback, the system receives input data intended to replace a specific portion of the song. This input data may consist of lyrics or phonetic content designated to modify an identified segment of the song and can be provided from various sources, including user input, software applications, or data retrieved from a user profile or database. Additionally, the input data may be generated automatically by the program as phonetic data or specified directly by the user in text or speech form, providing flexibility and control over the lyrical modifications.

In some embodiments, the system processes the selected music file by extracting the singing line, effectively isolating the vocal component from the instrumental data within the music file. In other embodiments, the first vocal data may retain both vocal and instrumental components. The first vocal data may be an audio or video segment, or data that captures, contains, or represents a vocal line, whether standalone, isolated, or combined with instrumental elements. The system may then identify a specific portion of this first vocal data for modification, referred to as the first voice part. The identification of this first voice part can be performed automatically by the system based on predefined criteria, or it can be specified by user input, allowing for customized vocal modification. The system also accepts or generates replacement lyrics that will substitute the original lyrics in the first voice part. These replacement lyrics can be provided directly by the user or generated automatically by the program, supporting both user-driven and autonomous content customization.

The system employs a singing voice model—a machine learning, neural network, or artificial intelligence model specifically trained to replicate the unique vocal characteristics of the original artist. This singing voice model is trained on data containing the artist's vocal characteristics, such as songs, voice profiles, or other relevant audio recordings, capturing the artist's distinct timbre, pitch, and style. During inference, the input data serves as a conditional, data informing the model to generate the second voice part, which mirrors the original singing voice or vocal characteristics while incorporating the new lyrics or phonetic content. This generated second voice part is then used to replace the first voice part in the first vocal data, creating a seamless vocal modification.

The modified vocal line, now incorporating the second voice part, is subsequently combined with the original instrumental data to produce an output music file. This output retains the authentic sound of the original song while integrating the updated lyrics or phonetic content, which appears naturally embedded as if performed by the original artist.

When a music file is selected by the user for streaming or playback, the system receives input data intended to replace a specific portion of the song. This input data may consist of lyrics or phonetic content designated to modify an identified segment of the song and can be provided from various sources, including user input, software applications, or data retrieved from a user profile or database. Additionally, the input data may be generated automatically by the program as phonetic data or specified directly by the user in text or speech form, providing flexibility and control over the lyrical modifications.

The system processes the selected music file by extracting the singing line, hereafter referred to as the first vocal data, which effectively isolates the vocal component from the instrumental data within the music file. The system may then identify the specific portion of the first vocal data for modification, referred to as the first voice part. The identification of this first voice part can be performed automatically by the system based on predefined criteria, or it can be specified by user input, allowing for customization of the vocal modification. The system also accepts or generates replacement lyrics that will substitute the original lyrics in the first voice part. These replacement lyrics can be provided directly by the user or generated automatically by the program, thus supporting both user-driven and autonomous content customization.

The system employs a singing voice model—a machine learning, neural network, or artificial intelligence model specifically trained to replicate the unique vocal characteristics of the original artist. This singing voice model is trained on data containing the artist's vocal characteristics, such as songs, voice profiles, or other relevant audio recordings, capturing the artist's distinct timbre, pitch, and style. During inference, the input data serves as a conditional, data informing the model to generate the second voice part, which mirrors the original vocal characteristics while incorporating the new lyrics or phonetic content. This generated second voice part is then used to replace the first voice part in the first vocal data, creating a seamless vocal modification.

In some embodiments, the modified vocal line, now incorporating the second voice part, is subsequently combined with the original instrumental data to produce an output music file. This output retains the authentic sound of the original song while integrating the updated lyrics or phonetic content, which appears naturally embedded as if performed by the original artist.

In some embodiments, a variety of artificial intelligence (AI), neural network (NN), or machine learning (ML) models may be employed to achieve the objectives of this invention. Such models are configured to capture and replicate critical vocal characteristics, including pitch, timbre, and rhythm, thereby enabling the modified lyrics or phonetic data to retain the distinctive vocal qualities of the original artist's style. The following examples of AI, NN, or ML models represent suitable options for implementation, although future models or alternative methodologies with comparable capabilities may also fall within the scope of this invention.

In some embodiments, Generative Adversarial Networks (GANs), such as VoiceGAN, may be utilized to achieve realistic audio generation by training a generator model and a discriminator model in tandem, allowing the GAN framework to capture and replicate detailed vocal characteristics. Additional models suitable for audio processing include Variational Autoencoders (VAEs) and Vector Quantized VAEs (VQ-VAEs), which, in some embodiments, can compress and reconstruct audio data, enabling flexible modification and synthesis of singing voice segments while preserving essential vocal features.

In some embodiments, text-to-speech (TTS) architectures, including Tacotron 2, FastSpeech 2, and NaturalSpeech 2, may be suitable for synthesizing voice from text-based inputs. These TTS models generate high-quality mel-spectrograms, which can then be converted into realistic singing voices using neural vocoders, such as WaveNet and HiFi-GAN. These vocoders are specifically suited for converting mel-spectrograms or latent representations into high-fidelity audio, enhancing the natural quality of synthesized voices.

In some embodiments, end-to-end singing voice synthesis models, such as NNSVS, DiffSinger, UniSyn, XiaiceSing, HiFiSinger, Sinsy, and VISinger2, may be employed. These models offer nuanced control over pitch, expression, and vocal style to emulate an artist's unique vocal characteristics. Such end-to-end models are particularly advantageous for applications that require detailed vocal control to maintain fidelity to an original artist's style.

Additional applicable models include YourTTS, which uses zero-shot voice cloning capabilities to enable expressive voice synthesis, and VITS, a versatile TTS model adaptable for singing applications. In some embodiments, MelGAN, an efficient GAN-based vocoder, facilitates real-time audio synthesis, making it particularly suitable for applications where processing speed is essential. In other embodiments, DeepSinger, a model trained for singing voice synthesis, captures expressive nuances of a singer's style, while iSTFTNet, a vocoder model, efficiently converts audio feature representations into high-fidelity singing audio. SV2TTS, a multi-stage TTS system with dedicated encoders for speaker identity and prosody, is also adaptable for singing synthesis, allowing granular control over an artist's vocal characteristics.

In some embodiments, Muskits, an ESPnet-based toolkit, provides a customizable framework for singing and speech synthesis, allowing integration with artist-specific vocal characteristics. While Muskits itself is not a standalone model, it enables flexible deployment of neural network-based models for singing synthesis and can be adapted to support various model architectures tailored to specific vocal outputs.

Enhancements such as Self-Supervised Learning (SSL) models, including HUBERT and MERT, may also be integrated in some embodiments to further refine the accuracy of pitch, rhythm, and vocal style replication. These SSL models leverage large-scale unsupervised data to improve the representation of vocal characteristics, allowing the system to maintain high fidelity to the artist's voice even with modified lyrics.

To facilitate model inference, the system may, in some embodiments, load or initialize a trained singing voice model specifically configured to reproduce the unique vocal characteristics of the original artist. This singing voice model may be trained on at least one song or audio file containing the artist's voice, thereby capturing the artist's distinctive timbre, pitch, and expressive style. Additionally, the model may be configured to accept conditional data that includes elements of the artist's voice or data specifying or capturing the artist's vocal characteristics, ensuring that the synthesized output faithfully replicates the artist's vocal style and quality.

In some embodiments, the trained singing voice model may be stored within the system, retrieved from an external source, or generated within the system. Training data may consist of either single-singer or multi-singer data. A single-singer model captures nuances unique to that artist, whereas a multi-singer model incorporates labeled vocal data from different artists, enabling the system to replicate individual vocal characteristics when needed. This flexibility allows the model to be tailored for applications requiring either high consistency in vocal replication or broad adaptability across multiple voices.

During inference, in some embodiments, the singing voice model may receive one or more conditions to guide its output. These conditions may include, but are not limited to: linguistic data, pitch information, loudness/intensity, singing expression and style, spectral features for voice quality, rhythmic timing and prosody, positional encoding for sequence alignment, artist-specific characteristics, self-supervised learning embeddings, and additional expressive features. These inputs or conditions can be applied individually or in combination, offering flexible application based on specific requirements.

In some embodiments, linguistic data includes phoneme sequences that encode phonetic information of the lyrics or phoneme duration to align pronunciation with musical rhythm, ensuring accurate pacing or both.

Pitch information may include pitch contour, providing melody in pitch values (e.g., MIDI or Hz), and pitch frame duration, defining sampling intervals to capture melody and variations typical in singing.

Loudness or intensity may include, in some embodiments, a loudness profile for volume levels and intensity variation for expressive dynamics like crescendos, adding emotional depth.

Singing expression and style may, in some embodiments, use expression embeddings from SSL models to capture tone (e.g., happy, sad) and style controls for particular nuances (e.g., vibrato-heavy singing).

Spectral features, including spectral tilt and formant frequencies, refine warmth and timbre, helping match the artist's unique vocal texture.

In some embodiments, rhythmic timing and prosody may involve beat and tempo alignment, while phrase markers allow natural pauses, ensuring synchronicity with musical structure.

Positional encoding for sequence alignment maintains synchronization within phoneme or music sequences, aiding temporal accuracy.

Conditioning on artist-specific characteristics applies artist embeddings, which retain the artist's vocal timbre.

SSL embeddings, such as from HuBERT or Wav2Vec2, offer acoustic quality for expressive delivery, enabling varied inflections.

Additional expressive features, such as vibrato rate and attack/decay parameters, may be included in some embodiments to enhance the realism of the vocal performance.

This structure allows conditions to be used flexibly, individually or in combination, to retain the artist's unique vocal characteristics while adjusting specific features to meet desired performance and stylistic needs.

In some embodiments, performing inference with the singing voice model is further conditioned on pitch contour data or musical notes. The pitch contour data provides a sequence of pitch values representing the melody of the original performance. This pitch contour serves as a guide for generating the second voice part so that the output aligns with the intended melody, reflecting the same melodic structure as the original voice part. By conditioning on pitch contour, the system ensures that the synthesized voice adheres closely to the musical nuances of the first voice part, helping maintain pitch accuracy and melodic continuity across the performance. In some embodiments, the data for the pitch contour or musical notes is extracted from the first voice part, where the system analyzes the original performance to determine the sequence of pitch values or musical notes over time.

In some embodiments, data for the pitch contour or musical notes is extracted from the first voice part, where the system analyzes the original performance to determine the sequence of pitch values or musical notes over time.

In some embodiments, additional conditioning parameters, including loudness profile, expression and style embeddings, spectral features, artist embedding, vibrato rate, and vibrato depth, may further refine model output. Loudness profiles adjust volume levels dynamically; expression embeddings provide emotional tone, and spectral features replicate timbre. Artist embeddings retain artist-specific vocal traits, while vibrato parameters replicate natural modulation, enhancing the realism of the synthesized voice.

In some embodiments, the first vocal data itself may serve as a conditioning factor when performing inference with the singing voice model. By using the original vocal data as a conditioning element, the system can more precisely guide the generation process, ensuring that the synthesized output not only reflects the intended lyrical modification but also aligns closely with the original performance's unique vocal characteristics, including pitch, rhythm, and expressive nuances. This conditioning approach enables the singing voice model to capture and replicate subtle vocal details inherent in the first vocal data, facilitating a highly accurate and artist-specific output that remains true to the original artist's style and delivery.

In some embodiments, the first vocal data and linguistic data are both used as conditioning inputs when performing inference with the singing voice model. By leveraging both the original vocal performance and the linguistic data representing the modified lyrics, the system enhances the accuracy of the synthesized output. This dual conditioning allows the singing voice model to maintain the original vocal characteristics of the first vocal data—such as pitch, rhythm, and expressive detail—while seamlessly incorporating the new lyrical content provided by the linguistic data. This approach ensures that the resulting output retains the authenticity of the artist's style and matches the intended lyrical modifications with high fidelity.

Through a process that includes performing inference, the output produced by the model, referred to as the second voice part, sounds as though the input lyrics are sung with substantially the same vocal characteristics as the original artist, thereby making it sound as though the same artist is singing the new lyrics.

Inference, which may involve synthesizing a singing voice using AI, NN, or ML models, may be referenced interchangeably with terms such as “synthesizing” or “generating.” These terms indicate that the system is performing an operation to produce a vocal output that retains the essential characteristics of the artist's voice while modifying or adapting certain aspects, such as lyrics, to meet the desired specifications.

Although specific models have been described, the invention is not limited to these examples. It is anticipated that advancements in AI, neural networks, and machine learning will yield additional models or variations that may be implemented within the invention to achieve similar vocal synthesis objectives.

Vocal characteristics may include one or more of pitch contour, timbre, spectral features, temporal dynamics, and intensity variations. Each characteristic represents a distinct, quantifiable attribute of a vocal performance, contributing to the unique vocal signature associated with an artist.

Pitch contour is represented as a sequence of pitch values capturing the melodic progression within a vocal performance. Each value in this sequence corresponds to a particular musical note and varies over time to establish the melody. Quantifying pitch contour may involve tracking the fundamental frequency (F0) at regular time intervals, facilitating objective measurement of both pitch accuracy and melodic structure. In some embodiments, for each frame in the first voice part and a corresponding frame in the second voice part, both frames occurring at the same time position, the difference in fundamental frequency between these frames is less than 10 percent, with each frame having a duration greater than 5 ms and less than 100 ms. By maintaining this threshold, the system ensures that the generated voice part closely aligns with the original melodic contour, thereby achieving substantial similarity in pitch.

Timbre refers to the tonal quality or color distinguishing one voice from another. Timbre may be influenced by specific spectral characteristics, including harmonic structure, formant frequencies, and spectral tilt. This aspect of vocal characteristics may be visualized and quantified using Mel-spectrograms or Mel Frequency Cepstral Coefficients (MFCCs), which capture the distribution of frequencies, harmonic content, and resonance within the voice, thereby providing a detailed profile of its tonal properties. In some embodiments, to maintain timbre similarity, the difference between the MFCCs of the first and second voice parts is less than 20%. This threshold helps to replicate the unique tonal color of the original voice, ensuring that the synthesized vocal output preserves the artist's distinctive timbre.

Spectral features encompass both harmonic and inharmonic content that collectively contribute to a voice's unique sound profile. Key spectral features may include formants (resonant frequencies shaping vowel sounds), spectral tilt (balance between low and high frequencies), and spectral centroid (perceived brightness of the sound). Spectral features are quantifiable through spectrogram analysis, which provides a visual and quantitative representation of the frequency components in a vocal performance over time. Maintaining similarity in spectral features allows the synthesized voice to retain the artist's unique tonal qualities, ensuring that the output voice captures the original spectral profile that contributes to the characteristic sound of the artist.

Temporal dynamics involve the timing, rhythm, and duration of vocal sounds, which contribute to expressiveness and phrasing within a vocal performance. Temporal dynamics include phoneme durations, representing the length of time each syllable or sound is sustained, along with pauses or breaths between phrases. These elements help ensure that a synthesized voice aligns with the rhythmic and expressive timing of the original performance, with phoneme duration playing a critical role in maintaining alignment with the underlying musical structure. By preserving these timing characteristics, the synthesized voice maintains the expressive phrasing that characterizes the original vocal style.

Intensity variations, also referred to as dynamics, encompass the loudness levels and variations throughout a performance, which contribute to emotional expression. Intensity may be measured using Root Mean Square (RMS) energy or decibel (dB) levels, allowing precise control over volume fluctuations. Dynamic variations, such as crescendo (gradual increase in volume) and decrescendo (gradual decrease), capture expressive changes in loudness over time, adding emotional depth to the synthesized vocal output. These intensity variations allow the system to preserve the emotional delivery inherent in the original performance, ensuring that the synthesized voice reflects the dynamic expressiveness associated with the artist's style.

In some embodiments, the input data may be received from the user, retrieved by the program from a server or memory within the system, or obtained from a third-party program. In some embodiments, the input data may be selected or generated by the program based on predefined criteria or user preferences. In some embodiments, the input data may consist of text or speech data that represents the lyrics intended for replacement. In some embodiments, the input data may comprise phonemes alone or phonemes paired with specific duration values for each phoneme, facilitating precise control over pronunciation and rhythm. In some embodiments, the input data may include phonemes combined with one or more of the conditional data described above, such as names of persons, places, items, or businesses, to enable dynamic personalization. Additionally, in some embodiments, the input data may include phrases, quotes, or other specified textual elements that enhance customization.

In some embodiments, the term “music data” or “music file” encompasses both audio-only formats and video formats that include audio components. This versatility ensures that the system can process and modify both audio and audiovisual content seamlessly, allowing applications to adapt to diverse media types without limitation. The audio component, whether part of an audio-only file or integrated into a video, may include music or songs performed by an artist. This encompasses vocal performances, instrumental tracks, or any combination thereof, enabling the system to extract, modify, and integrate customized vocal data into a wide range of media formats.

By supporting audio components in diverse contexts, such as standalone music files or synchronized audiovisual files, the invention provides flexibility for both streaming and downloading applications. This includes modifying the audio in music videos, live concert recordings, or standalone tracks, ensuring that the unique vocal characteristics of the original artist are retained across all output formats. This adaptability ensures the invention's applicability to evolving user demands in both traditional and digital media landscapes.

In some embodiments, the system employs a non-singing voice model trained to replicate the artist's voice for spoken content rather than singing. The non-singing voice model generates a spoken version of the input lyrics while preserving the artist's unique vocal characteristics, such as timbre, tone, and style. The spoken output is then transformed into a singing performance through speech-to-singing conversion or synthesis, aligning the output with the desired pitch, melody, and rhythm of the original song.

In some embodiments, the artist whose vocal characteristics are replicated by the system may be either a human artist or a virtual artist. A virtual artist refers broadly to any digitally created or synthesized persona that performs music or vocals, which may include AI-generated voices, fictional characters, or avatars designed to exhibit unique vocal styles or characteristics. Virtual artists can be defined through training data that captures specific vocal qualities, styles, or expressions, allowing the system to produce performances that sound as if performed by such virtual entities.

In some embodiments, The speech-to-singing conversion may be processed using artificial intelligence (AI), neural networks (NN), or machine learning (ML) techniques, ensuring the synthesized singing performance reflects both the musical and expressive qualities of the original artist.

The concepts disclosed herein may be applied within a number of different devices and computer systems, including, for example, general-purpose computing systems, singing synthesis systems, voice synthesis systems, and distributed computing environments.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers and voice synthesis processing should recognize that components and process steps described herein may be interchangeable with other components or steps, or combinations of components or steps, and still achieve the benefits and advantages of the present disclosure. Moreover, it should be apparent to one skilled in the art, that the disclosure may be practiced without some or all of the specific details and steps disclosed herein.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid-state memory, flash drive, removable disk, and/or other media. In addition, components of system may be implemented as in firmware or hardware.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without other input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

As used in this disclosure, the term “a” or “one” may include one or more items unless specifically stated otherwise. Further, the phrase “based on” is intended to mean “based at least in part on” unless specifically stated otherwise.

1. A system comprising:
at least one processor; and
memory including instructions operable to be executed by the at least one processor to configure the system to:
identify a first voice part in first vocal data that needs to be replaced, wherein the first vocal data captures a singing or vocal performance by an artist;
load or initialize a singing voice model, wherein the singing voice model is trained with at least one song or audio data containing the artist's voice, or is configured to take conditional data that includes the artist's voice or data specifying or capturing vocal characteristics of the artist;
generate linguistic data from input data;
generate a second voice part through a process that includes performing inference with the singing voice model conditioned on the linguistic data; and
replace the first voice part in the first vocal data with the second voice part to generate second vocal data;
wherein the singing voice model is developed, adapted, trained, or configured using neural network, machine learning, or artificial intelligence.

2. The system of claim 1, wherein the linguistic data comprises phonemes.

3. The system of claim 1, wherein the linguistic data comprises phonemes and the duration of each phoneme.

4. The system of claim 3, wherein syllabic melisma or syllabic compression is performed on the input data to generate the linguistic data.

5. The system of claim 1, wherein the memory further includes instructions that, when executed, further configure the system to: synthesize the second vocal data with instrumental data, wherein the first vocal data and the instrumental data are generated from music data or a music file.

6. The system of claim 1, wherein, for each frame in the first voice part and a corresponding frame in the second voice part, both frames occurring at the same time position, the difference in fundamental frequency between the frame of the first voice part and the frame of the second voice part is less than 5 percent, wherein the duration of each frame is greater than 5 ms and less than 100 ms.

7. The system of claim 1, wherein the memory further includes instructions that, when executed, further configure the system to:
receive user data from a music or video streaming platform;
generate the input data based on the user data or assign the user data as the input data; and
provide music or video including the second vocal data, or music or video generated with the second vocal data, for playback or output on a user device.

8. The system of claim 1, wherein the memory further includes instructions that, when executed, further configure the system to:
receive user data from a music or video downloading platform;
generate the input data based on the user data or assign the user data as the input data; and
provide music or video including the second vocal data, or music or video generated with the second vocal data, for download on a user device.

9. The system of claim 1, wherein the memory further includes instructions that, when executed, further configure the system to:
receive the name of a user as input data from a music or video streaming platform or a music downloading platform; and
provide music or video including the second vocal data, or music or video generated with the second vocal data, for streaming or download on a user device.

10. The system of claim 1, wherein the singing voice model encodes at least one parameter that represents the unique timbre of the artist's voice.

11. The system of claim 1, wherein performing inference with the singing voice model is further conditioned on a pitch contour or a sequence of musical notes.

12. The system of claim 11, wherein data for the pitch contour or the sequence of musical notes is extracted from the first voice part.

13. The system of claim 1, wherein the singing voice model data includes at least one value corresponding to at least one of intensity of phonation, increase or decrease of the intensity, singing expressions, or voice quality.

14. The system of claim 1, wherein the duration of the second voice part is shorter than the duration of the music data or file.

15. The system of claim 1, wherein the duration of the second voice part is less than 10% of the duration of the music data or file.

16. The system of claim 1, wherein the difference between Mel-Frequency Cepstral Coefficients of the second voice part and Mel-Frequency Cepstral Coefficients of at least a portion of the first vocal data is less than 20%.

17. The system of claim 1, wherein performing inference with the singing voice model is further conditioned on a loudness profile, expression and style embeddings, spectral features, artist embedding, vibrato rate, or vibrato depth.

18. The system of claim 1, wherein performing inference with the singing voice model is further conditioned on the first voice part.

19. The system of claim 1, wherein the input data is text or speech data.

20. A system comprising:
at least one processor; and
memory including instructions operable to be executed by the at least one processor to configure the system to:
load or initialize a singing voice model;
generate a voice part through a process that includes performing inference with the singing voice model conditioned on input data; and
serially extend a first audio segment with the voice part to generate a second audio segment, wherein the first audio segment captures a singing or vocal performance by an artist;
wherein the singing voice model data is developed, adapted, trained, or configured using neural network, machine learning, or artificial intelligence.

21. The system of claim 20, wherein the memory further includes instructions that, when executed, further configure the system to:
receive user data from a music or video streaming platform;
generate the input data based on the user data or assign the user data as the input data; and
provide music or video including the second audio segment, or music or video generated with the second audio segment, for playback or output on a user device.
